(19) United States
(12) Patent Application Publication
(10) Pub. No.: US 2023/0178713 A1
(43) Pub. Date: Jun. 8, 2023

(54) POSITIVE ELECTRODE FOR LITHIUM-ION SECONDARY BATTERY

(71) Applicant: TOYOTA JIDOSHA KABUSHIKI KAISHA, Toyota-shi (JP)

(72) Inventor: Momoko PROCTER, Seto-shi (JP)

(21) Appl. No.: 18/045,500

(22) Filed: Oct. 11, 2022

(30) Foreign Application Priority Data
Dec. 3, 2021 (JP) 2021-196620

(51) Int. Cl. H01M 4/36; H01M 10/0525; H01M 4/38

(52) U.S. Cl. CPC H01M 4/364; H01M 10/0525; H01M 4/382; H01M 2004/028

(57) ABSTRACT

A positive electrode for a lithium-ion secondary battery includes a positive electrode active material including tungsten. In measurement results of the positive electrode, WO₂, and WO₃ by XAFS analysis, spectra of rising positions of peaks of L-absorption edges of the tungsten included in the positive electrode active material, tungsten included in WO₂, and tungsten included in WO₃ satisfy (a−b)/(c−b)≤0.86. The rising positions are the range of 10,200 eV to 10,205 eV, “a” represents energy in a portion where the slope of a spectrum is steepest in the rising position in the measurement result of the positive electrode, “A” represents spectral intensity for a in the measurement result of the positive electrode, “b” represents energy in a portion where spectral intensity is A in a measurement result of WO₂, and “c” represents energy in a portion where spectral intensity is A in a measurement result of WO₃.

### CROSS-REFERENCE TO RELATED APPLICATION

This application claims priority to Japanese Patent Application No. 2021-196620 filed on Dec. 3, 2021, incorporated herein by reference in its entirety.

### BACKGROUND

### 1. Technical Field

The present disclosure relates to positive electrodes for lithium-ion secondary batteries.

### 2. Description of Related Art

Lithium-ion secondary batteries have been being put to practical use not only in small-sized power supplies for mobile phone applications, notebook computer applications, etc. but also in medium- and large-sized power supplies for automobile applications, electricity storage applications, etc.

Research focusing on positive electrode active materials has been carried out in order to improve the performance of lithium-ion secondary batteries.

For example, Japanese Unexamined Patent Application Publication No. 2021-018895 (JP 2021-018895 A) discloses a non-aqueous electrolyte secondary battery that includes a positive electrode including porous particles of a lithium composite oxide as a positive electrode active material. Each of the porous particles has a specific void ratio, includes two or more specific voids, and has on its surface a coating containing tungsten oxide (WO₃, hexavalent tungsten) and lithium tungstate. Such a positive electrode active material is used in order to provide a non-aqueous electrolyte secondary battery that has low initial resistance and that reduces an increase in resistance that is caused by repeated charging and discharging. Japanese Unexamined Patent Application Publication No. 2018-098183 (JP 2018-098183 A) describes a positive electrode active material for a lithium secondary battery that significantly reduces particle cracking after a cycle. This positive electrode active material includes a lithium composite metal compound in the form of secondary particles, and a lithium-containing tungsten oxide is present at least in spaces between primary particles. This positive electrode active material has a specific pore size distribution. JP 2018-098183 A describes that the lithium-containing tungsten oxide is either or both of Li₂WO₄ (hexavalent tungsten) and Li₄WO₅ (hexavalent tungsten).

Japanese Unexamined Patent Application Publication No. 2019-106379 (JP 2019-106379 A) discloses a positive electrode active material that reduces the amount of gas generated when a non-aqueous electrolyte secondary battery is stored at high temperatures. This positive electrode active material includes as core particles a lithium transition metal composite oxide with a layered structure including nickel, and a surface layer containing boron, tungsten, and oxygen in a specific state is present on the surfaces of the core particles. In JP 2019-106379 A, tungsten oxide (WO₃, hexavalent tungsten) is used to form the surface layer.

Japanese Unexamined Patent Application Publication No. 2019-073436 (JP 2019-073436 A) discloses a method for producing a nickel cobalt composite hydroxide that homogeneously contains tungsten inside primary particles and on the surfaces of the primary particles. A hexavalent tungsten raw material is used in JP 2019-073436 A.

### SUMMARY

A hexavalent tungsten raw material that is highly stable, low cost, and easily available is used as a tungsten raw material for a positive electrode active material. However, lithium tungstate coated with the surfaces of the porous particles of the lithium composite oxide disclosed in JP 2021-018895 A is not effective in lowering the activation energy. Moreover, tungsten oxide (WO₃, hexavalent tungsten) is poorly electrically conductive. Therefore, if the coverage is increased in order to improve cycle characteristics, resistance is increased. Lithium-ion secondary batteries using such positive electrodes as disclosed in JP 2021-018895 A, JP 2018-098183 A, JP 2019-106379 A, and JP 2019-073436 A still have high cell resistance, and further reduction in cell resistance is desired.

The present disclosure provides a positive electrode that, when used in a lithium-ion secondary battery, reduces the cell resistance of the secondary battery.

A positive electrode for a lithium-ion secondary battery according to a first aspect of the present disclosure includes a positive electrode active material including tungsten. In measurement results of the positive electrode, tungsten(IV) oxide represented by WO₂, and tungsten(VI) oxide represented by WO₃ by X-ray absorption fine structure (XAFS) analysis, spectra of rising positions of peaks of L-absorption edges of the tungsten included in the positive electrode active material, tungsten included in WO₂, and tungsten included in WO₃ satisfy

(a−b)/(c−b)≤0.86.

The rising positions are in a range of 10,200 eV to 10,205 eV. “a” represents energy (eV) in a portion where a slope of a spectrum is steepest in the range of 10,200 eV to 10,205 eV in a measurement result of the positive electrode by the XAFS analysis. “A” represents spectral intensity for a (eV) in the measurement result of the positive electrode by the XAFS analysis. “b” represents energy (eV) in apportion where spectral intensity is A in the range of 10,200 eV to 10,205 eV in a measurement result of WO₂ by the XAFS analysis. “c” represents energy (eV) in a portion where spectral intensity is A in the range of 10,200 eV to 10,205 eV in a measurement result of WO₃ by the XAFS analysis.

In the positive electrode for a lithium-ion secondary battery according to the first aspect of the present disclosure, a content of the tungsten included in the positive electrode active material with respect to the positive electrode active material may be 0.015% by mass to 3.1% by mass.

In the positive electrode for a lithium-ion secondary battery according to the first aspect of the present disclosure, (a−b)/(c−b) may be 0.15 or more and 0.65 or less.

In the positive electrode for a lithium-ion secondary battery according to the first aspect of the present disclosure, the positive electrode active material may include a lithium metal composite oxide, and the tungsten included in the positive electrode active material may be included at least in a surface of the positive electrode active material.

The present disclosure can provide a positive electrode for a lithium-ion secondary battery that reduces the cell resistance of the lithium-ion secondary battery.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a graph showing X-ray absorption fine structure (XAFS) spectra of an example of a positive electrode for a lithium-ion secondary battery of the present disclosure (positive electrode sample), WO₂, and WO₃;

FIG. 2 is a schematic graph showing in a partially enlarged manner the rising positions of the peaks of the L-absorption edges of tungsten in the XAFS spectra of the positive electrode sample, WO₂, and WO₃, and illustrating Expression (1) of the present disclosure; and

FIG. 3 is a sectional view schematically showing a part of a stacked structure of an electrode assembly of a lithium-ion secondary battery of the present disclosure.

### DETAILED DESCRIPTION OF EMBODIMENTS

Hereinafter, an embodiment according to the present disclosure will be described. It should be noted that matters other than those specifically mentioned in the present specification and necessary to carry out the present disclosure (for example, a general configuration and production process of a lithium-ion secondary battery that do not characterize the present disclosure) may be regarded as design matters of those skilled in the art based on the common general technical knowledge in the art. The present disclosure may be carried out based on the content disclosed in the present specification and the common general technical knowledge in the art. The dimensional relationships (such as length, width, and thickness) in the drawings do not reflect the actual dimensional relationships. In the present specification, a hyphen “-” or word “to” indicating a numerical range is used to mean an inclusive range in which the numerical values before and after “-” or “to” are included as its lower and upper limit values. Any combination of values can be used as upper and lower limit values of a numerical range.

Positive Electrode for Lithium-Ion Secondary Battery

A positive electrode for a lithium-ion secondary battery according to the present disclosure includes a positive electrode active material including tungsten. In measurement results of the positive electrode, tungsten(IV) oxide represented by WO₂, and tungsten(VI) oxide represented by WO₃ by X-ray absorption fine structure (XAFS) analysis, spectra of rising positions of peaks of L-absorption edges of the tungsten included in the positive electrode active material, tungsten included in WO₂, and tungsten included in WO₃ satisfy the following Expression (1).

(a−b)/(c−b)≤0.86 (1)

The rising positions are in a range of 10,200 eV to 10,205 eV. In Expression (1), “a” represents energy (eV) in a portion where a slope of a spectrum is steepest in the range of 10,200 eV to 10,205 eV in a measurement result of the positive electrode by the XAFS analysis. “A” represents spectral intensity for a (eV) in the measurement result of the positive electrode by the XAFS analysis. “b” represents energy (eV) in a portion where spectral intensity is A in the range of 10,200 eV to 10,205 eV in a measurement result of WO₂ by the XAFS analysis. “c” represents energy (eV) in a portion where spectral intensity is A in the range of 10,200 eV to 10,205 eV in the measurement result of WO₃ by the XAFS analysis.

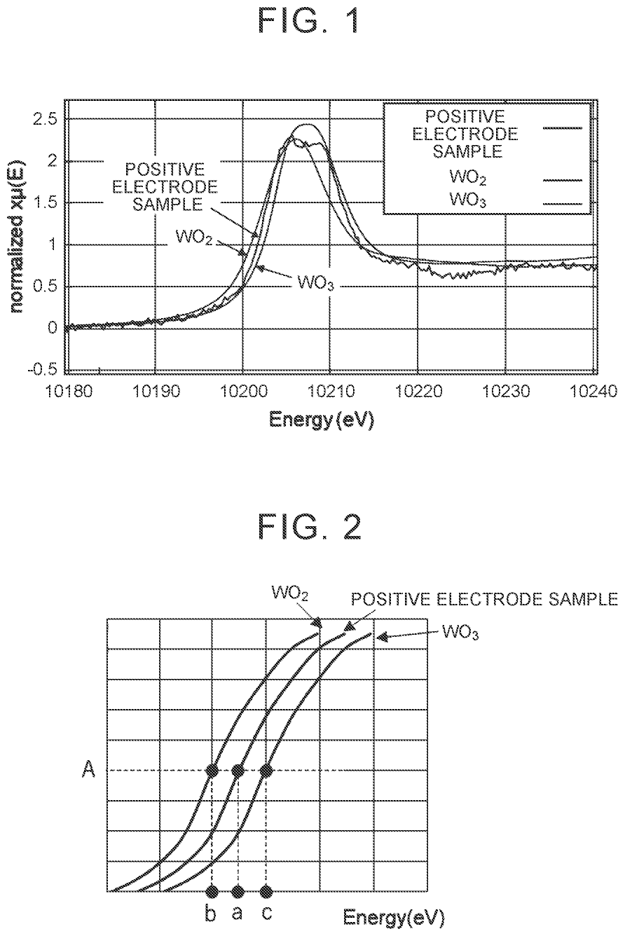

FIG. 1 is a graph showing X-ray absorption fine structure (XAFS) spectra of an example of the positive electrode for a lithium-ion secondary battery of the present disclosure (positive electrode sample), WO₂, and WO₃. FIG. 1 shows spectra of the example of the positive electrode for a lithium-ion secondary battery of the present disclosure (positive electrode sample), WO₂ (tungsten(IV) oxide), and WO₃ (tungsten(VI) oxide) as measured by XAFS, each spectrum including the rising position (10,200 eV to 10,205 eV) of the peak of the L-absorption edge of tungsten (hereinafter, such spectra are sometimes simply referred to as “XAFS tungsten spectra”).

FIG. 2 is a schematic graph showing in a partially enlarged manner the rising positions of the peaks of the L-absorption edges of tungsten in the XAFS spectra of the positive electrode sample, WO₂, and WO₃, and illustrating Expression (1) of the present disclosure.
The rising position of the peak of the L-absorption edge of tungsten in the XAFS spectrum is said to represent the valence of tungsten. In the present disclosure, “a” represents the energy (eV) when the spectrum slope is steepest in the rising position (10,200 eV to 10,205 eV) of the peak of the L-absorption edge of tungsten in the XAFS spectrum of the positive electrode sample, and “a” is used as an index of the rising position of the peak. The value “a” can be identified as the energy corresponding to the peak top of differentiation when the spectrum in the range of 10,200 eV to 10,205 eV is differentiated. When “A” represents the spectral intensity for “a” (eV), “b” represents the energy (eV) in a portion where the spectral intensity is A in the range of 10,200 eV to 10,205 eV of WO₂ (tungsten(IV) oxide), and “c” represents the energy (eV) in a portion where the spectral intensity is A in the range of 10,200 eV to 10,205 eV of WO₃ (tungsten(VI) oxide).
In this example, WO₂ is used as a standard sample of tetravalent tungsten, and WO₃ is used as a standard sample of hexavalent tungsten.

When (a−b)/(c−b) in the above Expression (1) is 1, this is interpreted as tungsten in the positive electrode being hexavalent. When (a−b)/(c−b) in the above Expression (1) is 0, this is interpreted as tungsten in the positive electrode being tetravalent. When the above Expression (1) “(a−b)/(c−b)≤0.86” is satisfied, this is interpreted as tungsten in the positive electrode being tetravalent or having an average valence between four and six. Tungsten having an average valence between four and six is considered to be a mixture of tetravalent tungsten and hexavalent tungsten. This tungsten has a lower average valence than hexavalent tungsten, is highly electrically conductive, and is effective in lowering the activation energy. Therefore, when tungsten in the positive electrode is tetravalent or has an average valence between four and six, this tungsten is highly electrically conductive and is effective in lowering the activation energy, and is therefore considered to reduce the cell resistance. Tungsten having a low valence tends to form a solid solution with nickel (Ni), cobalt (Co), manganese (Mn), etc. that is used for a positive electrode active material. It is considered that when this tungsten forms a solid solution with Ni, Co, Mn, etc., the lattice spacing in the crystal structure of the positive electrode active material is increased, so that the diffusion resistance of lithium ions can be reduced. As described above, the spectrum of the rising position (10,200 eV to 10,205 eV) of the peak of the L-absorption edge of tungsten in a positive electrode as measured by XAFS satisfies the following Expression (1).

(a−b)/(c−b)≤0.86 (1)

It is thus possible to provide a positive electrode for a lithium-ion secondary battery that reduces the cell resistance of the lithium-ion secondary battery.

In the positive electrode, (a−b)/(c−b) in Expression (1) may be 0.65 or less, 0.60 or less, 0.55 or less, or 0.50 or less in order to further reduce the cell resistance. For the positive electrode, (a−b)/(c−b) in Expression (1) may be 0.15 or more in order to further reduce the cell resistance. The XAFS measurements of the positive electrode for a lithium-ion secondary battery of the present disclosure, WO₂, and WO₃ for obtaining (a−b)/(c−b) in Expression (1) can be performed by the method that will be described later in Examples.

Positive Electrode Active Material

The positive electrode for a lithium-ion secondary battery of the present disclosure includes a positive electrode active material, and the positive electrode active material includes tungsten. The positive electrode active material of the present disclosure may contain a lithium metal composite oxide as an essential component, or may contain a lithium metal composite oxide with a layered structure. Examples of the lithium metal composite oxide include lithium nickel composite oxides, lithium manganese composite oxides, lithium cobalt composite oxides, lithium nickel cobalt aluminum composite oxides, lithium iron nickel manganese composite oxides, and lithium nickel cobalt manganese composite oxides. Among these, the lithium metal composite oxide may be a lithium nickel cobalt manganese composite oxide due to its higher resistance characteristics. In the present specification, the “lithium nickel cobalt manganese composite oxide” is a term including, in addition to oxides containing lithium (Li), nickel (Ni), cobalt (Co), manganese (Mn), and oxygen (O) as constituent elements, oxides further containing one or more of additional elements other than these elements. Examples of such additional elements include transition metal elements and main-group metal elements such as magnesium (Mg), calcium (Ca), aluminum (Al), titanium (Ti), vanadium (V), chromium (Cr), silicon (Si), yttrium (Y), zirconium (Zr), niobium (Nb), molybdenum (Mo), hafnium (Hf), tantalum (Ta), tungsten (W), sodium (Na), iron (Fe), zinc (Zn), and tin (Sn). The additional elements may be metalloid elements such as boron (B), carbon (C), silicon (Si), and phosphorus (P) or non-metal elements such as sulfur (S), fluorine (F), chlorine (Cl), bromine (Br), and iodine (I). The content of each of these additional elements may be 0.1 mol or less with respect to lithium. The same applies to the lithium nickel composite oxides, the lithium cobalt composite oxides, the lithium manganese composite oxides, the lithium nickel cobalt aluminum composite oxides, the lithium iron nickel manganese composite oxides, etc. The form of the positive electrode active material may be a known form, and may be particles. The particle size of the positive electrode active material may be similar to a known particle size.

Tungsten included in the positive electrode active material of the present disclosure may be present anywhere in the positive electrode active material. In the positive electrode active material of the present disclosure, tungsten may be present on the surface of the positive electrode active material, may be included inside the lithium metal composite oxide in the positive electrode active material, or may be present both on the surface of the positive electrode active material and inside the lithium metal composite oxide in the positive electrode active material. The positive electrode active material of the present disclosure may include tungsten at least on its surface.

The form of tungsten when tungsten is present on the surface of the positive electrode active material is not particularly limited. For example, the entire surface of the positive electrode active material or a part of the surface of the positive electrode active material may be coated with a tungsten compound. The coating of the tungsten compound may be granular, and the granular coating may be present in a dispersed manner on the surface of the positive electrode active material. The positive electrode active material may be porous particles, and the tungsten compound may be present not only on the outside surface of the positive electrode active material but also on the inside surface of the positive electrode active material (that is, the surface inside the positive electrode active material). The positive electrode active material may be secondary particles formed by agglomeration of primary particles of the positive electrode active material, or may be secondary particles formed by agglomeration of the granular coating and the particles of the positive electrode active material, and the tungsten compound may be present on the inside surfaces of the secondary particles of the positive electrode active material (the surface inside the positive electrode active material). When tungsten is present on the inside surface of the positive electrode active material, the tungsten tends to form a solid solution with the lithium metal composite oxide, and the tungsten is incorporated into the lithium metal composite oxide in the positive electrode active material and increases the lattice spacing in the crystal structure of the positive electrode active material. The diffusion resistance of lithium ions can thus be easily reduced. In order to reduce the cell resistance, the positive electrode active material of the present disclosure may include tungsten at least on its surface and a part of tungsten may be incorporated into the lithium metal composite oxide, or the positive electrode active material of the present disclosure may include tungsten on the outside and inside surfaces and a part of tungsten may be incorporated into the lithium metal composite oxide. The positions where tungsten is present in the positive electrode active material of the present disclosure can be analyzed by, for example, transmission electron microscope-energy dispersive X-ray (TEM-EDX) analysis.

The content of tungsten with respect to the positive electrode active material is not particularly limited, but may be, for example, 0.010% by mass or more, 0.015% by mass or more, 0.1% by mass or more, 0.4% by mass or more, 4.0% by mass or less, or 3.1% by mass or less in order to reduce the cell resistance. The content of tungsten with respect to the positive electrode active material can be obtained by elemental analysis using radio frequency inductively coupled plasma (ICP) emission spectroscopic analysis, and specifically, can be obtained by the method that will be described later in Examples.

Tungsten included in the positive electrode active material of the present disclosure may be tetravalent tungsten, or may be such a mixture of tetravalent tungsten and hexavalent tungsten that the XAFS tungsten spectra are in the range that satisfies the above Expression (1). Examples of a tetravalent tungsten compound included in the positive electrode active material include WO₂, lithium tungstate containing tetravalent tungsten, and lithium nickel cobalt manganese composite oxides containing tetravalent tungsten. The positive electrode active material may include WO₂ in order to reduce the cell resistance. Examples of a hexavalent tungsten compound included in the positive electrode active material include WO₃, lithium tungstate containing hexavalent tungsten such as Li₂WO₄, and lithium nickel cobalt manganese composite oxides containing hexavalent tungsten, but the positive electrode active material may include either or both of WO₃ and Li₂WO₄ in order to reduce the cell resistance.

A method for producing the positive electrode active material including tungsten in the present disclosure is not particularly limited as long as the XAFS tungsten spectra satisfy the above Expression (1). A method capable of producing a positive electrode active material as a final product can be used as appropriate as the method for producing the positive electrode active material. The method for producing the positive electrode active material including tungsten in the present disclosure is, for example, a method using at least a tetravalent tungsten raw material, because a positive electrode active material which includes tungsten and of which the XAFS tungsten spectra satisfy the above Expression (1) can be easily produced. When a tetravalent tungsten raw material and a hexavalent tungsten raw material are used, the method for producing the positive electrode active material including tungsten in the present disclosure is, for example, a method in which the ratio between the tetravalent tungsten raw material and the hexavalent tungsten raw material is adjusted as appropriate so that the XAFS tungsten spectra satisfy the above Expression (1). Examples of the tetravalent tungsten raw material include WO₂ and WCl₄, but the tetravalent tungsten raw material may be WO₂ in order to reduce the cell resistance. Examples of the hexavalent tungsten raw material include WO₃ and lithium tungstate containing hexavalent tungsten such as Li₂WO₄, but the hexavalent tungsten raw material may be either or both of WO₃ and Li₂WO₄ in order to reduce the cell resistance. Tetravalent tungsten can become stable hexavalent tungsten by, for example, firing at a high temperature. Therefore, the ratio between tetravalent tungsten and hexavalent tungsten included in the produced positive electrode active material may be different from the ratio between the tetravalent tungsten raw material and the hexavalent tungsten raw material used in the production of the positive electrode active material.

The method for producing the positive electrode active material including tungsten is, for example, a method in which a tungsten raw material is added in substantially at least one of the following known steps 1 to 3. Particularly, the method for producing the positive electrode active material including tungsten may be a method in which a tungsten raw material including at least tetravalent tungsten is added in at least one of the following steps 2 and 3, because a positive electrode active material which includes tungsten and of which the XAFS tungsten spectra satisfy the above Expression (1) can be easily produced.

Step 1: The step of causing metal components (raw material compounds) to react in water under a predetermined temperature condition (e.g., room temperature to 60° C.) to prepare a precursor (coprecipitated precursor) composed of a metal compound.
Step 2: The step of preparing a mixture including the precursor and a lithium compound and firing the mixture to produce a lithium metal composite oxide.
Step 3: The step of coating the surface of the lithium metal composite oxide with a compound determined as necessary.

For example, in the case where a tungsten raw material including at least tetravalent tungsten is added in step 2, step S2 may be the step of preparing a mixture including the precursor, the lithium compound, and the tungsten raw material and firing the mixture to produce a lithium metal composite oxide. The firing can be performed at a temperature of approximately 750° C. to 950° C. in an atmospheric atmosphere. The firing time may be approximately 8 hours to 20 hours. The ratio between tetravalent tungsten and hexavalent tungsten included in the positive electrode active material can also be adjusted as appropriate by the firing temperature and firing time. The order in which the precursor, the lithium compound, and the tungsten raw material are mixed in step 2 is not particularly limited.

For example, in the case where a tungsten raw material including at least tetravalent tungsten is added to form a coating on the surface of the lithium metal composite oxide in step 3, a known method for forming a coating on a active material can be used as appropriate. An example of the known method is a mechanochemical process that is performed using various mechanochemical devices. For example, by using a mixing device such as an automatic mortar and performing milling using a ball mill, a planetary mill, a bead mill, etc., a desired mechanochemical reaction can be caused to form a coating on at least a part of the surface of the lithium metal composite oxide. After the mechanochemical process, heat treatment may be performed at a temperature of approximately 80° C. to 300° C. for approximately 0.5 hours to 5 hours.

The positive electrode for a lithium-ion secondary battery of the present disclosure may further include other components in addition to the positive electrode active material. The positive electrode for a lithium-ion secondary battery of the present disclosure may include a positive electrode active material layer on one or both sides of a positive electrode current collector. The positive electrode current collector has a function to collect current from the positive electrode active material layer. Examples of the material of the positive electrode current collector include aluminum, stainless steel (SS), nickel, chromium, gold, zinc, iron, and titanium. Examples of the form of the positive electrode current collector include foil, plate, and mesh.

The positive electrode active material layer may include, for example, an electrically conductive material, a binder, etc. as necessary, in addition to the positive electrode active material. The electrically conductive material is not particularly limited as long as it can improve the electrically conductive properties of the positive electrode active material layer. Examples of the electrically conductive material include carbon black such as acetylene black and Ketjenblack, carbon nanotubes (CNTs), and carbon nanofibers (CNFs). Examples of the binder include polyvinylidene fluoride (PVDF), polytetrafluoroethylene (PTFE), butadiene rubber (BR), and styrene-butadiene rubber (SBR).

The content of the positive electrode active material in the positive electrode active material layer is not particularly limited, but may be 70% by mass or more, or 80% by mass or more. The content of the electrically conductive material in the positive electrode active material layer is not particularly limited, but may be 1% by mass or more and 15% by mass or less, or 3% by mass or more and 13% by mass or less. The content of the binder in the positive electrode active material layer is not particularly limited, but may be 1% by mass or more and 15% by mass or less, or 1.5% by mass or more and 10% by mass or less.

The thickness of the positive electrode active material layer varies depending on, for example, the intended use of the battery, but may be 10 μm or more and 250 μm or less, 20 μm or more and 200 μm or less, or 30 μm or more and 150 μm or less.

The positive electrode for a lithium-ion secondary battery of the present disclosure includes a positive electrode active material including tungsten, and can be produced by using a known production method as appropriate as long as the XAFS tungsten spectra satisfy the above Expression (1).

Lithium-Ion Secondary Battery

A lithium-ion secondary battery of the present disclosure may include the positive electrode for a lithium-ion secondary battery of the present disclosure, a negative electrode, and a non-aqueous electrolyte.

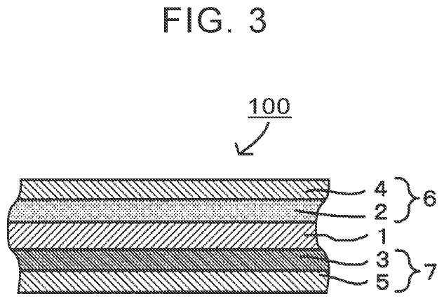

FIG. 3 is a sectional view schematically showing apart of a stacked structure of an electrode assembly of the lithium-ion secondary battery of the present disclosure. The electrode assembly of the lithium-ion secondary battery of the present disclosure is not necessarily limited to this example. An electrode assembly 100 of the lithium-ion secondary battery includes: a positive electrode 6 including a positive electrode active material layer 2 and a positive electrode current collector 4; a negative electrode 7 including a negative electrode active material layer 3 and a negative electrode current collector 5; and a separator 1 interposed between the positive electrode 6 and the negative electrode 7. The positive electrode 6 is the positive electrode for a lithium-ion secondary battery of the present disclosure. The positive electrode 6 may include a positive electrode lead (not shown) connected to the positive electrode current collector 4. The lithium-ion secondary battery of the present disclosure may further include an outer body (not shown). The electrode assembly 100 and the non-aqueous electrolyte may be housed in the outer body. The outer body may be, for example, a metal case. Specific examples of the shape of the case include a coin, a flat plate, a cylinder, and a laminate. The outer body may be, for example, a pouch made of an aluminum laminated film.

The negative electrode 7 includes the negative electrode active material layer 3 containing a negative electrode active material. The negative electrode used in the present disclosure may usually include the negative electrode current collector 5 and a negative electrode lead (not shown) connected to the negative electrode current collector 5, in addition to the negative electrode active material layer 3. The negative electrode active material is not particularly limited as long as it can store and release lithium ions. Examples of the negative electrode active material include metallic lithium, lithium alloys, metal oxides containing lithium elements, metal sulfides containing lithium elements, metal nitrides containing lithium elements, carbon materials such as graphite, hard carbon, and soft carbon, and Si. The negative electrode active material may be graphite. Graphite may be natural graphite or artificial graphite, or may be amorphous carbon-coated graphite, namely graphite coated with an amorphous carbon material.

The negative electrode active material layer may contain components other than the negative electrode active material, such as, for example, a binder and a thickener, as necessary. Examples of the binder include styrene-butadiene rubber (SBR) and polyvinylidene fluoride (PVDF). An example of the thickener is carboxymethyl cellulose (CMC).

The content of the negative electrode active material in the negative electrode active material layer may be 90% by mass or more, or may be 95% by mass or more and 99% by mass or less. The content of the binder in the negative electrode active material layer may be 0.1% by mass or more and 8% by mass or less, or may be 0.5% by mass or more and 3% by mass or less. The content of the thickener in the negative electrode active material layer may be 0.3% by mass or more and 3% by mass or less, or may be 0.5% by mass or more and 2% by mass or less.

The thickness of the negative electrode active material layer is not particularly limited, but may be, for example, 10 μm or more and 100 μm or less, or may be m or more and 50 μm or less. The negative electrode current collector has a function to collect current from the negative electrode active material layer. For example, stainless steel (SS), copper (Cu), nickel (Ni), iron (Fe), titanium (Ti), cobalt (Co), or zinc (Zn) can be used as the material of the negative electrode current collector. The form of the negative electrode current collector may be similar to that of the positive electrode current collector described above.

The separator 1 used in the present disclosure is interposed between the positive electrode and the negative electrode to suppress these electrodes from coming into direct contact with each other. The separator 1 has a plurality of fine pores through which lithium ions that are charge carriers pass. The charge carriers move through the fine pores during charging and discharging. For example, an insulating resin such as polyethylene (PE), polypropylene (PP), polyester, or polyamide can be used for the separator 1. The separator 1 may be a laminated sheet of two or more layers of these resins. An example of such a laminated sheet is a three-layer sheet in which PP, PE, and PP are laminated in this order. A heat resistant layer (HRL) may be provided on a surface of the separator 1. The thickness of the separator 1 may be, for example, 10 μm or more and 30 μm or less.

The non-aqueous electrolyte typically contains a non-aqueous solvent and a supporting salt. Organic solvents such as various carbonates, ethers, esters, nitriles, sulfones, and lactones that are used for electrolytes of common lithium-ion secondary batteries can be used as the non-aqueous electrolyte without particular limitation. Specific examples include ethylene carbonate (EC), propylene carbonate (PC), diethyl carbonate (DEC), dimethyl carbonate (DMC), ethyl methyl carbonate (EMC), monofluoroethylene carbonate (MFEC), difluoroethylene carbonate (DFEC), monofluoromethyldifluoromethyl carbonate (F-DMC), and trifluorodimethyl carbonate (TFDMC). One of such non-aqueous solvents may be used alone, or two or more may combined as appropriate. The supporting salt is, for example, a lithium salt such as LiPF₆, LiBF₄, or lithium bis(fluorosulfonyl)imide (LiFSI). The concentration of the supporting salt may be 0.7 mol/L or more and 1.3 mol/L or less.

The lithium-ion secondary battery can be produced by adding the non-aqueous electrolyte to the electrode assembly. Known configurations can be selected and used as appropriate as the other configurations of the lithium-ion secondary battery of the present disclosure. For example, see JP 2021-018895 A.

Hereinafter, the present disclosure will be described more specifically based on Examples and Comparative Example. However, the present disclosure is not limited to the Examples.

### Example 1

Preparation of Positive Electrode Active Material

A raw material aqueous solution containing nickel sulfate, cobalt sulfate, and manganese sulfate in a molar ratio of 1:1:1 was prepared. A reaction solution with its pH adjusted with sulfuric acid and aqueous ammonia was prepared in a reaction vessel. A sodium hydroxide aqueous solution was also prepared as a pH adjusting solution. The raw material aqueous solution was added to the reaction solution at a predetermined rate while stirring, and was neutralized with the pH adjusting solution. A crystallized product was washed with water, filtered, and dried to obtain composite hydroxide particles (precursor particles). The obtained precursor particles and lithium carbonate were mixed so that the molar ratio (Li/Me) of lithium (Li) to the total (Me) of nickel, cobalt, and manganese was 1.1. The mixture was fired in an electric furnace at 870° C. for 15 hours. After the fired mixture was cooled in the furnace to room temperature, a crushing process was performed to obtain a lithium metal composite oxide (LiNi_{1/3}Co_{1/3}Mn_{1/3}O₂) that was spherical fired powder formed by agglomeration of primary particles. A predetermined amount of tungsten(IV) oxide (WO₂) was mixed with the obtained lithium metal composite oxide, namely the spherical fired powder, to satisfy tungsten (W)/(lithium metal composite oxide+WO₂)=0.6% by mass. The mixture was processed with a mechanochemical device at 3,000 rpm for 30 minutes, and heat-treated at 150° C. for an hour to obtain a lithium metal composite oxide having a coating of tungsten(IV) oxide (WO₂) as a positive electrode active material. The obtained positive electrode active material was analyzed by transmission electron microscope-energy dispersive X-ray (TEM-EDX) analysis. A granular coating was present in a dispersed manner on the outside surface of the positive electrode active material. Point analysis was performed. In the analysis, the granular coating was considered to be the outside surface, and the portion from the surface of the remainder excluding the granular coating to a depth of 10 nm was considered to be the inside surface. The analysis results showed that tungsten was present in the outside and inside surfaces. The granular coating in the outside surface contained 69% by mass of tungsten, and the inside surface contained 0.4% by mass of tungsten. The rate of content of tungsten was obtained by W/(total mass in the analyzed range) and was obtained as an average of measured values at three positions. The obtained positive electrode active material was analyzed by transmission electron microscope-energy dispersive X-ray (TEM-EDX) analysis. The analysis results also showed that tungsten had been incorporated into primary particles of the lithium metal composite oxide.

Production of Positive Electrode

The prepared positive electrode active material, acetylene black (AB) as an electrically conductive material, and polyvinylidene fluoride (PVDF) as a binder were mixed in an N-methylpyrrolidone (NMP) in a mass ratio of positive electrode active material:AB:PVDF of 90:8:2 to prepare a paste for forming a positive electrode active material layer. This paste was applied to both sides of aluminum foil with a thickness of 15 μm, dried, and then pressed to produce a positive electrode.

Production of Lithium-Ion Secondary Battery for Evaluation

Natural graphite (C) as a negative electrode active material, styrene-butadiene rubber (SBR) as a binder, and carboxymethyl cellulose (CMC) as a thickener were mixed in ion-exchanged water in a mass ratio of C:SBR:CMC of 98:1:1 to prepare a paste for forming a negative electrode active material. This paste was applied to both sides of copper foil with a thickness of 10 μm, dried, and then pressed to produce a negative electrode.

Two porous polyolefin sheets having a three-layer structure of PP/PE/PP and having a thickness of 24 μm were prepared as separator sheets. The produced positive and negative electrodes and the prepared two separator sheets were placed on to of each other and wound to produce a wound electrode assembly. Electrode terminals were attached to the positive and negative electrodes of the produced wound electrode assembly by welding, and the resultant wound electrode assembly was housed in a battery case having a liquid injection port.

Subsequently, a non-aqueous electrolyte was injected from the liquid injection port of the battery case, and the liquid injection port was hermetically sealed. An electrolyte produced by dissolving LiPF₆ as a supporting salt at a concentration of 1.0 mol/L in a mixed solvent containing ethylene carbonate (EC), dimethyl carbonate (DMC), and ethyl methyl carbonate (EMC) in a volume ratio of 3:4:3 was used as the non-aqueous electrolyte. A lithium-ion secondary battery for evaluation was thus obtained.

### Examples 2, 5, and 6

Positive electrode active materials were prepared in a manner similar to that of Example 1 except that tungsten(IV) oxide (WO₂) and tungsten(VI) oxide (WO₃) were used instead of tungsten(IV) oxide (WO₂) and at least one of the following conditions were changed in the preparation of the positive electrode active material of Example 1 so that the value of (a−b)/(c−b) of each positive electrode active material became as shown in Table 1: the addition proportions of WO₂ and WO₃, and the heat treatment temperature (100° C. to 200° C.) and heating time (0.5 hours to 2 hours) of WO₂ and WO₃ and the positive electrode active material.

Positive electrodes and lithium-ion secondary batteries for evaluation were produced in a manner similar to that of Example 1 by using the obtained positive electrode active materials.

### Comparative Example 1

A positive electrode active material was prepared in a manner similar to that of Example 1 except that tungsten(VI) oxide (WO₃) was used instead of tungsten(IV) oxide (WO₂) in the preparation of the positive electrode active material of Example 1.

A positive electrode and a lithium-ion secondary battery for evaluation were produced in a manner similar to that of Example 1 by using the obtained positive electrode active material.

### Example 3

Composite hydroxide particles (precursor particles) were obtained in a manner similar to that of Example 1 in the preparation of the positive electrode active material of Example 1. Predetermined amounts of the obtained precursor particles, lithium carbonate, tungsten(IV) oxide (WO₂), and tungsten(VI) oxide (WO₃) were mixed (W/(lithium metal composite oxide+WO₂+WO₃)=0.45% by mass), and the mixture was fired in an electric furnace at 870° C. for 15 hours. The lithium carbonate was mixed so that the molar ratio (Li/Me) of lithium (Li) to the total (Me) of nickel, cobalt, and manganese was 1.1. After the fired mixture was cooled in the furnace to room temperature, a crushing process was performed to obtain, as a positive electrode active material, spherical fired powder formed by agglomeration of primary particles. The obtained positive electrode active material was analyzed by transmission electron microscope-energy dispersive X-ray (TEM-EDX) analysis. A granular coating was present in a dispersed manner on the outside surface of the positive electrode active material. Point analysis was performed. In the analysis, the granular coating was considered to be the outside surface, and the portion from the surface of the remainder excluding the granular coating to a depth of 10 nm was considered to be the inside surface. The analysis results showed that tungsten was present in the outside and inside surfaces. The granular coating in the outside surface contained 65% by mass of tungsten, and the inside surface contained 0.9% by mass of tungsten. The content of tungsten was obtained by W/(total mass in the analyzed range) and was obtained as an average of measured values at three positions. The obtained positive electrode active material was analyzed by transmission electron microscope-energy dispersive X-ray (TEM-EDX) analysis. The analysis results also showed that tungsten had been incorporated into primary particles of the lithium metal composite oxide. A positive electrode and a lithium-ion secondary battery for evaluation were produced in a manner similar to that of Example 1 by using the obtained positive electrode active material.

### Examples 4 and 7 to 12

Positive electrode active materials were prepared in a manner similar to that of Example 3 except that at least one of the following conditions were changed in the preparation of the positive electrode active material of Example 3 so that the value of (a−b)/(c−b) of each positive electrode active material became as shown in Table 1 or Table 2: the addition proportions of tungsten(IV) oxide (WO₂) and tungsten(VI) oxide (WO₃) or lithium tungstate (Li₂WO₄), the addition amounts of tungsten(IV) oxide (WO₂) and tungsten(VI) oxide (WO₃) or lithium tungstate (Li₂WO₄), the firing temperature (830° C. to 900° C.), and the firing time (13 hours to 16 hours). Positive electrodes and lithium-ion secondary batteries for evaluation were produced in a manner similar to that of Example 1 by using the obtained positive electrode active materials.

Evaluation

Measurement of Tungsten Content in Positive Electrode Active Material

1 g of each of the obtained positive electrode active materials was weighed, and was heated with a heater at 300° C. in a mixed solution of 5 ml of commercially available nitric acid and 10 ml of a commercially available hydrogen peroxide solution until total dissolution was able to be visually confirmed. The residue was filtered out, and the volume of the filtered solution was adjusted to 100 ml with pure water. The content of tungsten elements (mass %) was measured based on ICP emission spectroscopic analysis. An ICP emission spectroscopic analyzer made by Hitachi High-Tech Science Corporation was used for the ICP emission spectroscopic analysis.

X-Ray Absorption Fine Structure (XAFS) Measurement of Positive Electrode

XAFS measurement was performed on the positive electrodes obtained in the Examples and Comparative Example by using a device described below. XAFS measurement was also performed on tungsten(IV) oxide (WO₂) and tungsten(VI) oxide (WO₃) that were standard samples by using the device described below. The value of (a−b)/(c−b) in the above Expression (1) was obtained from the spectra of the rising positions (10,200 eV to 10,205 eV) of the peaks of the L-absorption edges of tungsten as measured by XAFS.

Device: Hard X-ray XAFS in the Aichi Synchrotron Radiation Center operated by Aichi Science & Technology Foundation
Measurement range: 9,897 eV to 11,297 eV (peak position of L-absorption edge of tungsten)
Measurement method: The positive electrodes were measured by a fluorescence method, and the tungsten compounds were measured by a transmission method.
The transmission method for measuring each tungsten compound that is a standard substance detects X-rays transmitted through the tungsten compound when the tungsten compound is irradiated with incident X-rays. The fluorescence method for measuring the positive electrode detects fluorescent X-rays generated when the positive electrode is irradiated with incident X-rays. Therefore, the measurement results of both methods can be similarly expressed in spectra although these methods are different in measurement method. Tungsten in each tungsten compound that is a standard substance and tungsten in the positive electrode can be compared by normalizing the XAFS measurement data using analysis software “Athena.” In order to obtain the reproducibility of Expression (1), the standard samples were measured each time the positive electrode sample was measured, and a slight deviation was corrected. The results of (a−b)/(c−b) in Expression (1) of Examples 1 to 12 and Comparative Example 1 are shown in Table 1 or Table 2.

Resistance Measurement

Each of the lithium-ion secondary batteries for evaluation produced in the Examples and Comparative Example was placed in an environment of 25° C. Activation (initial charging) was performed by a constant current-constant voltage method. Each lithium-ion secondary battery for evaluation was fully charged by performing constant current charging to 4.2 V at a current value of 1/3 C and then performing constant voltage charging until the current value becomes 1/50 C. Thereafter, each lithium-ion secondary battery for evaluation was discharged to 3.0 V at a constant current value of 1/3 C. Each of the activated lithium-ion secondary batteries for evaluation was adjusted to an open circuit voltage of 3.70 V. Each lithium-ion secondary battery for evaluation was then placed in a temperature environment of −28° C. Each lithium-ion secondary battery for evaluation was discharged at a current value of 20 C for eight seconds, and a voltage drop ΔV was obtained. Next, the battery resistance was calculated as initial resistance by dividing the voltage drop ΔV by the discharge current value (20 C). The ratio of the initial resistance of each Example to the initial resistance of Comparative Example 1 was obtained, where the initial resistance of Comparative Example 1 was taken as 1.00. The results are shown in Table 1 or Table 2.

TABLE 1

| | (a − b)/ | Normalized |
|---|---|---|
| | (c − b) | Resistance |
| Comparative | 1 | 1.00 |
| Example 1 | | |
| Example 1 | 0 | 0.86 |
| Example 2 | 0.15 | 0.70 |
| Example 3 | 0.4 | 0.71 |
| Example 4 | 0.65 | 0.73 |
| Example 5 | 0.8 | 0.88 |
| Example 6 | 0.86 | 0.87 |

TABLE 2

| | (a − b)/ | W/active material | Normalized |
|---|---|---|---|
| | (c − b) | (mass %) | Resistance |
| Example 3 | 0.4 | 0.45 | 0.71 |
| Example 7 | 0.34 | 0.010 | 0.91 |
| Example 8 | 0.45 | 0.015 | 0.80 |
| Example 9 | 0.36 | 1.5 | 0.78 |
| Example 10 | 0.55 | 2.9 | 0.85 |
| Example 11 | 0.26 | 3.1 | 0.76 |
| Example 12 | 0.38 | 4.0 | 0.95 |

As can be seen from the results of the performance evaluation in Tables 1 and 2, it was confirmed that the positive electrodes for a lithium-ion secondary battery of Examples 1 to 12 in which the XAFS tungsten spectra satisfied the above Expression (1) of (a−b)/(c−b)≤0.86 reduced the cell resistance of the lithium-ion secondary battery. According to the present disclosure, the cell resistance of the lithium-ion secondary battery can further be reduced by using a positive electrode in which a positive electrode active material includes either tetravalent tungsten or tungsten having an average valence between four and six so that the XAFS tungsten spectra satisfy Expression (1): (a−b)/(c−b)≤0.86.

What is claimed is:

1. A positive electrode for a lithium-ion secondary battery, the positive electrode comprising a positive electrode active material including tungsten, wherein
in measurement results of the positive electrode, tungsten(IV) oxide represented by WO₂, and tungsten(VI) oxide represented by WO₃ by X-ray absorption fine structure (XAFS) analysis, spectra of rising positions of peaks of L-absorption edges of the tungsten included in the positive electrode active material, tungsten included in WO₂, and tungsten included in WO₃ satisfy
(a−b)/(c−b)≤0.86,
the rising positions are in a range of 10,200 eV to 10,205 eV,
a represents energy (eV) in a portion where a slope of a spectrum is steepest in the range of 10,200 eV to 10,205 eV in a measurement result of the positive electrode by the X-ray absorption fine structure analysis,
A represents spectral intensity for a (eV) in the measurement result of the positive electrode by the X-ray absorption fine structure analysis,
b represents energy (eV) in a portion where spectral intensity is A in the range of 10,200 eV to 10,205 eV in a measurement result of WO₂ by the X-ray absorption fine structure analysis, and
c represents energy (eV) in a portion where spectral intensity is A in the range of 10,200 eV to 10,205 eV in a measurement result of WO₃ by the X-ray absorption fine structure analysis.

2. The positive electrode according to claim 1, wherein a content of the tungsten included in the positive electrode active material with respect to the positive electrode active material is 0.015% by mass to 3.1% by mass.

3. The positive electrode according to claim 1, wherein (a−b)/(c−b) is 0.15 or more and 0.65 or less.

4. The positive electrode according to claim 1, wherein:
the positive electrode active material includes a lithium metal composite oxide; and
the tungsten included in the positive electrode active material is included at least in a surface of the positive electrode active material.
